(19) United States
(12) Patent Application Publication
(10) Pub. No.: US 2005/0021288 A1
(43) Pub. Date: Jan. 27, 2005

(54) Method for obtaining the distribution of a function of many random variables

(76) Inventors: Robin Daniel Willink, Karori (NZ); Blair Durham Hall, Waikanae (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/837,255

(22) Filed: Apr. 30, 2004

Related U.S. Application Data
(63) Continuation-in-part of application No. PCT/NZ02/00228, filed on Oct. 30, 2002.

(30) Foreign Application Priority Data
Oct. 30, 2001 (NZ) 515188

(51) Int. Cl. G06F 15/00

(52) U.S. Cl. 702/181

(57) ABSTRACT

A method for determining a characteristic of the output distribution of a function whose inputs include random variables includes the steps of: retrieving data relating to one or more input random variables in computer memory, determining at least the first and second moments of each input random variable from the retrieved data, determining at least the first and second moments of the output of the function from at least the first and second moments of the input random variables, and storing or displaying the moments of the output of the function in computer memory.

### FIELD OF INVENTION

The present invention relates to a method for determining the output or the output distribution of a function whose inputs are a plurality of random variables by combining the moments of the input random variables to determine the moments of the output of the function.

### BACKGROUND

Some systems involve functions of several input random variables. Systems of this type include the propagation of uncertainty in measurement systems, the analysis of risk in engineering, financial and inventory systems, forecasting using models with uncertain inputs or uncertain parameters, and the estimation of dose distribution in radiotherapy treatment. In such systems, users solving the system are interested in deriving the distribution of the output of the function. This could be for the purpose of quoting an interval representing a range of values that might reasonably be attributed to the output of the function.

Currently, if the functions and distributions of the input variables are sufficiently complicated, as they usually are, a Monte Carlo study of the measurement process is used to estimate the output distribution. The quality of the interval derived using a Monte Carlo study increases with the number of trials. A disadvantage of increasing the number of trials in a Monte Carlo system is that the required computational time also increases.

### SUMMARY OF INVENTION

It is the object of the present invention to provide an alternative method for estimating an output interval or an output distribution of a function whose inputs are random variables that overcomes the disadvantages mentioned above or to at least provide the public with a useful choice.

In broad terms in one aspect the invention comprises a method for determining a characteristic of the output distribution of a function whose inputs include random variables including the steps of: retrieving data relating to one or more input random variables in computer memory, determining at least the first and second moments of each input random variable from the retrieved data, determining at least the first and second moments of the output of the function from at least the first and second moments of the input random variables, and storing or displaying the moments of the output of the function in computer memory.

The characteristic may be moments of the output of the function, a coverage interval enclosing a specified proportion of the distribution of the output, or the output distribution of the function.

The method may further include the steps of determining at least the first four moments for each input random variable.

The method may further include the step of determining at least the first four moments for the output of the function.

The method may further include the step of determining the index of skewness (\sqrt{β₁}) for the output of the function.

The method may further include the step of determining the index of kurtosis (β₂) for the output of the function.

The method may further include the step of fitting a distribution to the function with the same mean, variance, index of skewness and index of kurtosis as the output of the function.

The distribution fitted to the output of the function may be a Pearson distribution. Alternatively the distribution may be a Johnson distribution or a Burr distribution or any other suitable distribution.

The method may further include the step of retrieving a percentage of the distribution of the output to be represented and determining an interval enclosing that percentage.

If a coverage interval is determined equal parts of the upper and lower ends of the distribution may be excluded from the interval.

If an input random variable has a distribution with an infinite tail or tails the method further may further include the steps of truncating the distribution and renormalizing the truncated distribution. Preferably any truncation is sufficiently far away from the bulk of the distribution so as to have minimal effect on the moments of the input random variable and on the moments of the output of the function.

In broad terms in a further aspect the invention comprises a moment-determining system configured to take as input one or more random variables and to output the moments of the output of the function, the system comprising: data relating to one or more input random variables stored in computer memory, an input-moment determiner configured to retrieve the data relating to each input random variable from computer memory, determine at least the first and second moments of each input random variable from the retrieved data, and an output-moment determiner configured to determine at least the first and second moments of the output of the function from at least the first and second moments of the input random variables, and an output determiner configured to store the moments of the output of the function in computer memory or display the moments.

In broad terms in a further aspect the invention comprises an interval-determining system configured to take as input one or more random variables and to output an interval containing a specified proportion of the distribution of a function having as input the random variables, the system comprising: data relating to one or more input random variables stored in computer memory, an input-moment determiner configured to retrieve the data relating to each input random variable from computer memory and determine at least the first and second moments of each input random variable from the retrieved data, and an output-moment determiner configured to determine at least the first and second moments of the output of the function as a function of at least the first and second moments of the input random variables, and an output determiner configured to determine an interval containing a proportion of the output distribution of the function from the determined moments of the output of the function and store the interval in computer memory or display the interval.

The interval-determining system may be further configured to determine at least the first four moments of each input random variable from the retrieved data.

The interval-determining system may be further configured to determine at least the first four moments for the output of the function from the moments of the input random variables.

The interval-determining system may be further configured to determine the index of skewness (\sqrt{β₁}) for the output of the function from the moments of the output of the function.

The interval-determining system may be further configured to determine the index of kurtosis (β₂) for the output of the function from the moments of the output of the function.

The interval-determining system may be further configured to retrieve the percentage of the distribution of the output to be represented and determine an interval enclosing that percentage.

The interval-determining system may be further configured to truncate and renormalize the distribution of any input random variable that has a distribution with an infinite tail or tails.

In broad terms in a further aspect the invention comprises a distribution-calculation system configured to take as input one or more random variables and to output the distribution of a function having as input the random variables, the system comprising: data relating to one or more input random variables stored in computer memory, an input-moment determiner configured to retrieve the data relating to each input random variable from computer memory and determine at least the first and second moments of each input random variable from the retrieved data, and an output-moment determiner configured to determine at least the first and second moments of the output of the function as a function of at least the first and second moments of the input random variables, and an output determiner configured to fit a distribution to the output of the function with the same moments as those determined for the output of the function from the moments of the random input variables of the function, and store parameters describing the fitted distribution in computer memory or display the distribution.

The distribution-calculation system may be further configured to determine at least the first four moments for each input random variable.

The distribution-calculation system may be further configured to determine at least the first four moments for the output of the function.

The distribution-calculation system may be further configured to determine the index of skewness (\sqrt{β₁}) for the output of the function from the moments of the output of the function.

The distribution-calculation system may be further configured to determine the index of kurtosis (β₂ ) for the output of the function from the moments of the output of the function.

The distribution-calculation system may be further configured to fit a distribution to the output of the function with the same mean, variance, index of skewness and index of kurtosis as those determined for the output of the function.

The distribution-calculation system may be further configured to fit a Pearson distribution to the output of the function. Alternatively the distribution-calculation system may be further configured to fit a Johnson distribution or a Burr distribution or any other suitable distribution to the output of the function.

The distribution-calculation system may be further configured to truncate and renormalize the distribution of any input random variable that has a distribution with an infinite tail or tails.

### BRIEF DESCRIPTION OF DRAWINGS

A preferred form system and method of the invention will be further described with reference to the accompanying figures by way of example only and without intending to be limiting, wherein;

FIG. 1 is a flow chart setting out the main steps of the method of the invention.

FIG. 2A is a flow chart setting out in detail one preferred method of performing step 2 of the flow chart of FIG. 1,

FIG. 2B is a flow chart setting out in detail one preferred method of performing step 3 of the flow chart of FIG. 1,

FIG. 3 shows a range of different distributions described by the Pearson system,

FIG. 4 shows the range of \sqrt{β₁} and β₂ values for which distributions exist,

FIG. 5 is a flow chart showing the mathematical steps required to determine the moments of the output of the function whose input are random variables using the method of the invention for Example 2, and

FIG. 6 is a chart showing one possible computer implementation of the method of the invention.

### DETAILED DESCRIPTION

In many systems it is desired to know the output distribution of a function or an interval enclosing a certain percentage of the output of the function whose inputs are random variables. Such systems include analysis of risk in financial or inventory systems, the analysis of risk in engineering systems, forecasting using models with uncertain inputs or uncertain parameters, the propagation of uncertainty in measurement systems, and the estimation of dose distribution in radiotherapy treatment.

The system can be written as
θ=F(θ₁,θ₂, . . . ,θₙ)
where F is a known functional relationship between the inputs and the outputs, θ is the output of the function and θᵢ are the input random variables. In this case the number n of input random variables is known.

If the function F involves only various elementary linear and non-linear operations then manipulation of the statistical moments of the input random variables {θᵢ} can provide the moments of the output of the function θ. The distribution of θ can then be approximated by a known distribution with the same moments as those determined for θ. Using the known distribution an interval enclosing a specified proportion of the distribution of θ can be obtained.

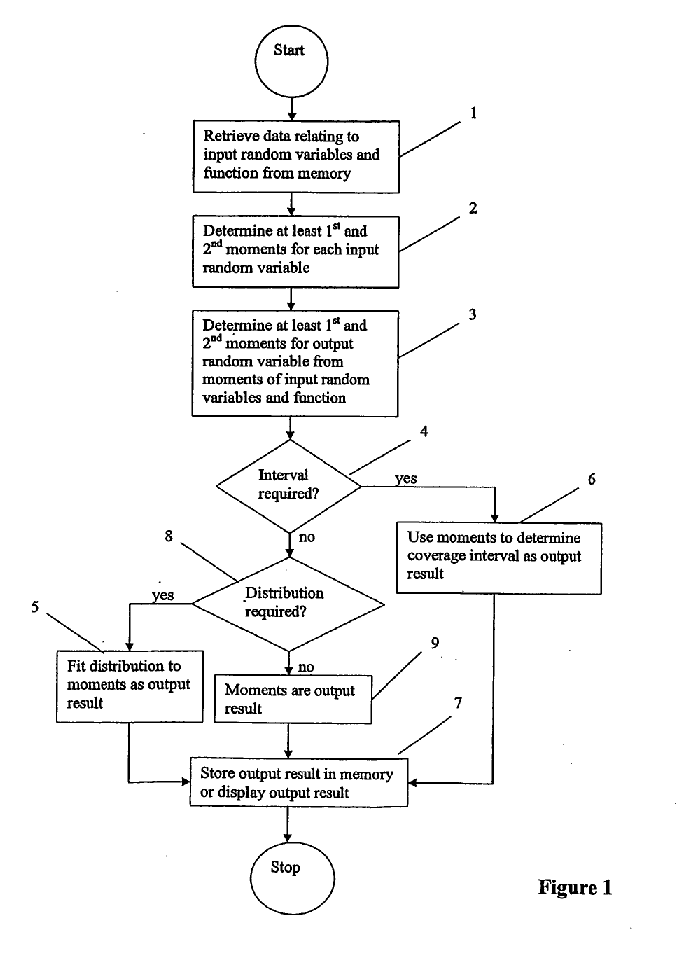

FIG. 1 is a flow chart showing one preferred method for determining the moments and a distribution or coverage interval for the output of a function whose inputs include random variables. Step 1 of the method is to retrieve data relating to the input random variables from memory. At least the first and second moments for each of the independent random variables are determined in the input-moment determiner shown as step 2. In step 3 the moments of the output of the function are determined from the moments of the input of the function in the output-moment determiner. Step 4 allows a choice of determining a coverage interval for the output of the function using the moments in step 6. If it is not desired to determine a coverage interval, step 8 allows a choice of fitting a distribution to the moments as the output result. This is done in step 5. Alternatively the moments are the output results as shown in step 9. In step 7 the output result is stored in memory or displayed. The display may be a computer monitor or a printed page or any other suitable form of display.

The first step is to retrieve data relating to the input random variables and the function. The data relating to the input random variables may be in any suitable form. For example, the data for any variable may be a sample, a set of moments, or the specification of a standard input distribution. The function F may either be retrieved from memory or may be provided in some other way. If a coverage interval is required then the percentage of the output distribution to be enclosed by the interval is retrieved.

The first step in determining a distribution or coverage interval of the output of the function is to find the moments of each input variable of the function as described in step 2 of FIG. 1.

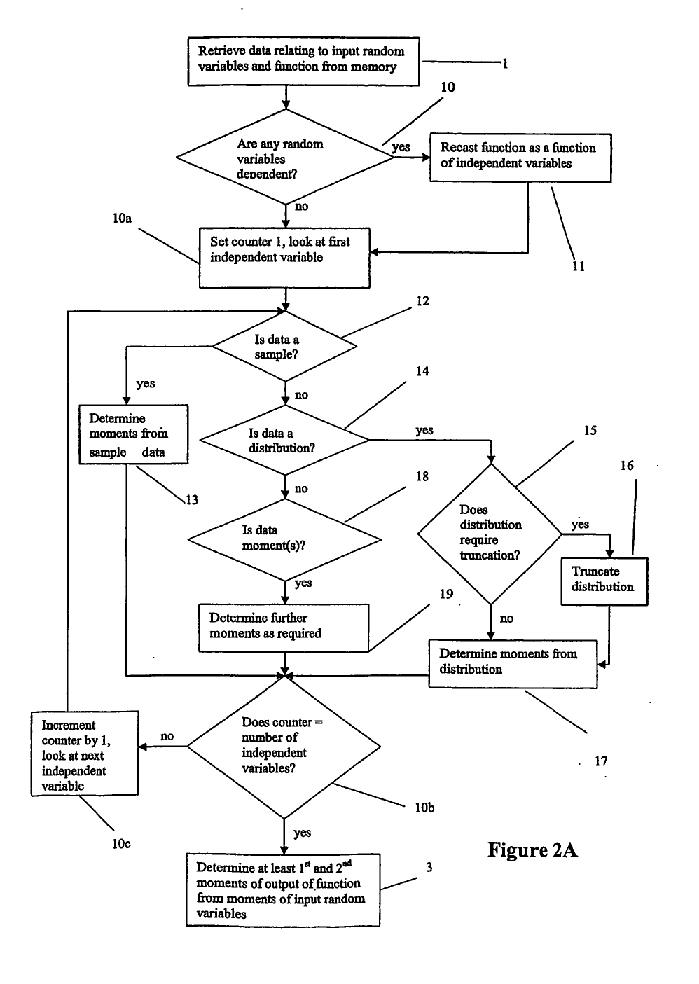

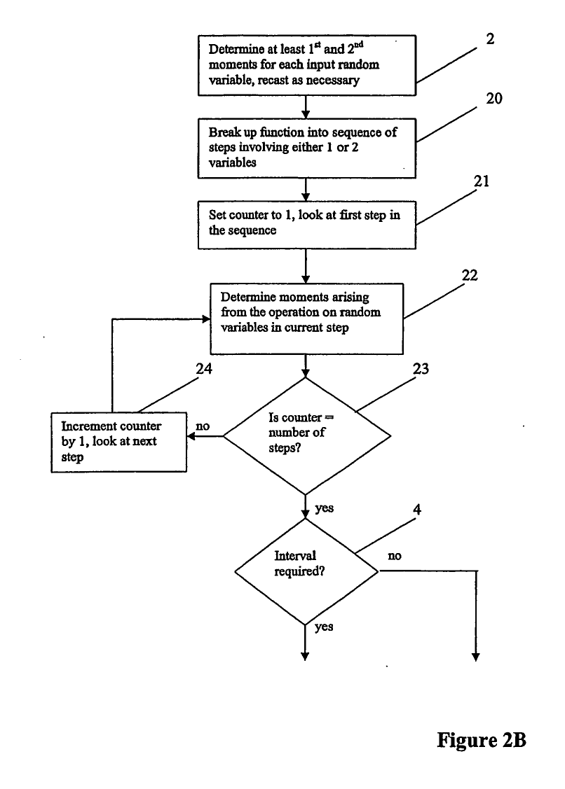

FIG. 2A is a flow chart showing the input-moment determiner as a series of steps that may form step 2 of FIG. 1. FIG. 2A starts with the step of retrieving the data relating to the input random variables and the function. Step 10 asks the questions of whether the input random variables are all independent or whether any of the input random variables are dependent on other input random variables.

If some of the input random variables of the function are not independent then the dependencies have to be treated by some other means in order to recast the problem in the required form. For example, if θ=θ₁θ₂+θ₃ where θ₁ and θ₂ are dependent on each other but not on θ₃ then the equation can be rewritten as θ=θ₄+θ₃ where θ₄≡θ₁θ₂ and θ₃ are independent. The method of the invention can then be applied if the moments of θ₄ are calculable. Also, for example, if θ=θ₁θ₂, where θ₁ and θ₂ are dependent normal variables with a known correlation ρ, then it is known that an equivalent expression for the function is θ=ρθ₁²+(1−ρ²)^{1/2}θ₅ where θ₁ and θ₅ are independent normal variables.

After querying whether the random variables are independent and recasting the random variables as necessary a counter is set in step 10a. This counter forms the basis of the loop of steps 10a to 10c. The loop means that steps 12 to 19 are repeated for each independent random variable.

The next question is in what form is the input data for any variable provided. In FIG. 2A this is shown as a series of questions boxes (12, 14, 18) that ask whether the data for the input variable is a sample, the specifications for a distribution or a set of moments. It should be noted that the order in which these questions are asked is not important.

If the input random variable is provided as a distribution then the distribution may require truncation to avoid the problem of higher order moments becoming unmanageably large or infinite.

The central moments of some common distributions of random variables will now be described.

Some standard input distributions of input random variables are the t-distribution with v degrees of freedom (denoted as tᵥ), the normal distribution with zero mean and unit variance (denoted N(0,1)), the symmetric triangular distribution on the interval from −1 to 1 (denoted T[−1,1]), the uniform distribution on the same interval (denoted U[−1,1]), the arcsine distribution on the same interval (denoted ASTN[−1,1]), and the standard exponential distribution, which has mean 1, (denoted EXP(1)).

The arcsine distribution describes the distribution of random observations of a quantity that is oscillating sinusoidally. It has undefined density at its limits, and it is the only distribution described in the table that is U-shaped. Its name arises from its distribution function, which, for the case in the table, is

$${\int }_{- 1}^{y} {f}_{x} ( x ) ⅆ x = \frac{1}{2} + ( {sin}^{- 1} y ) / π .$$

Table 1 shows some standard distributions with their density functions and their moments.

TABLE 1

| Variable | Density function | Central moments |
|---|---|---|
| tᵥ | ${[ 1 + ( {x}^{2} / v ) ]}^{- ( v + 1 ) / 2}$ | ${μ}_{r} = {v}^{r / 2} \frac{1 \cdot 3 … ( r - 1 )}{( v - 2 ) ( v - 4 ) … ( v - r )} r = 2 , 4 , …$ |
| N(0, 1) | $exp ( - {x}^{2} / 2 ) / \sqrt{2 π}$ | ${μ}_{r} = \frac{r !}{{2}^{r / 2} ( r / 2 ) !} r = 2 , 4 , …$ |
| T[−1, 1] | $1 - \vert x \vert \vert x \vert \leq 1$ | ${μ}_{r} = \frac{2}{( r + 1 ) ( r + 2 )} r = 2 , 4 , …$ |
| U[−1, 1] | $0.5 \vert x \vert \leq 1$ | ${μ}_{r} = 1 / ( r + 1 ) r = 2 , 4 , …$ |
| ASIN[−1, 1] | ${( 1 - {x}^{2} )}^{- 1 / 2} \vert x \vert \leq 1$ | ${μ}_{r} = \frac{1 \cdot 3 … ( r - 1 )}{2 \cdot 4 … r} r = 2 , 4 , …$ |
| EXP(1) | ${e}^{- x} x > 0$ | ${μ}_{r} = r {μ}_{r - 1} + {( - 1 )}^{r} r = 0 , 1 , 2 , …$ |

Preferably the method of the invention uses truncated and renormalized forms of standard distributions with infinite tails. For example let tea) denote a variable with a t-distribution with v degrees of freedom truncated at the points −a and +a and renormalized. Further let N(0,1,a) denote a variable with the standard normal distribution similarly truncated at the points −a and +a and renormalized. The odd central moments of t da) and N(0,1,a) are zero, and the even central moments are given in Table 2 below. Further let EXP(1,a) denote a standard exponential distribution truncated at a and renormalized. The moments about zero of EXP(1,a) are also given in Table 2.

TABLE 2

| Variable | Moments |
|---|---|
| tᵥ(a) | $\begin{matrix}{μ}_{r} = {v}^{r / 2} B ( \frac{r + 1}{2} ; \frac{v - r}{2} ; \frac{{a}^{2}}{v + {a}^{2}} ) / B ( \frac{1}{2} ; \frac{v}{2} ; \frac{{a}^{2}}{v + {a}^{2}} ) \\ r = 2 , 4 , …\end{matrix}$ |
| N(0, 1, a) | ${μ}_{r} = {2}^{r / 2} γ ( \frac{r + 1}{2} ; \frac{{a}^{2}}{2} ) / γ ( \frac{1}{2} ; \frac{{a}^{2}}{2} ) r = 2 , 4 , …$ |
| EXP(1, a) | ${μ}_{r}^{′} = γ ( r + 1 ; a ) / γ ( 1 ; a ) r = 0 , 1 , 2 , …$ |

In Table 2

$$B ( ϕ ; φ ; x ) ≡ {\int }_{0}^{x} {{z}^{ϕ - 1} ( 1 - z )}^{φ - 1} ⅆ z$$

is the incomplete beta function and

$$γ ( ϕ ; x ) ≡ {\int }_{0}^{x} {z}^{ϕ - 1} exp ( - z ) ⅆ z$$

is the incomplete gamma function.

Truncation and renormalization of variables with distributions with infinite tails has the advantage of avoiding the problem of the higher order moments of these variables becoming unmanageably large or infinite. The degree of truncation required is so slight that the truncated and full distributions are visually indistinguishable when plotted.

After assessing the form of the input data and truncating input data distributions as necessary, at least the first and second moments are determined for each independent input random variable.

The moments of a variable X are either written as moments about zero or as central moments, i.e. moments about the mean.

Moments about zero for variable X are written as
μ′ᵣ≡E[X^{r}] r=0, 1, . . . , 1
where E[·] denotes expectation. The identity of the variable is denoted by writing μ′ᵣ(X). The mean of X is μ′₁.

Central moments for variable X are written as
μᵣ≡E[(X−μ′₁)^{r}] r=0, 1, . . . , 2

For any variable μ₀=1, μ₁=0 and μ₂ is the variance.

The two equations relating the sets of moments are

$$\begin{matrix}{μ}_{r} = {\sum }_{j = 0}^{r} {( - 1 )}^{j} ( \begin{matrix}r \\ j\end{matrix} ) {( {μ}_{1}^{′} )}^{j} {μ}_{r - j}^{′} & 3 \\ {μ}_{r}^{′} = {\sum }_{j = 0}^{r} ( \begin{matrix}r \\ j\end{matrix} ) {( {μ}_{1}^{′} )}^{j} {μ}_{r - j} & 4\end{matrix}$$

These equations allow a user to determine the central moments from the moments about zero and vice versa.

In general the distribution of a variable can be completely described by its moments. The first and second moments are the mean and variance of the distribution and determine the location and scale of the distribution. The third order central moment and higher order central moments provide shape information for the distribution. The third order moment describes the asymmetry, or “skewness”, of the distribution and the fourth order moment describes the peakedness, or “kurtosis”, of the distribution.

In addition to determining the moments of each input variable, cumulants of each input variable may also be determined. The cumulants of a variable are related to the moments of that variable. In particular, the first four cumulants together determine the location, scale, skewness and kurtosis of the distribution. The first cumulant κ₁ is the mean. Higher order cumulants are determined by the central moments and are given by

$${κ}_{r} = {μ}_{r} - {\sum }_{j = 1}^{r - 2} ( \begin{matrix}r - 1 \\ j\end{matrix} ) {κ}_{r - j} {μ}_{j} r \geq 2 \qquad 5$$

In particular κ₂=μ₂, κ₃=μ₃ and κ₄=μ₄−3μ₂². The inverse transform is

$${μ}_{r} = {\sum }_{j = 0}^{r - 2} ( \begin{matrix}r - 1 \\ j\end{matrix} ) {κ}_{r - j} {μ}_{j} r \geq 2 \qquad 6$$

These equations are more easily calculable than equation 3 because they do not contain oscillating signs. Thus, once the central moments or cumulants are known the other can be determined without the risk of rounding errors produced by the previous transformation equations.

Two corrections for a departure from normality of the distribution of a variable can be made using moment ratios
\sqrt{β₁}≡κ₃/κ₂^{3/2}=μ₃/μ₂^{3/2} 7
β₂≡(κ₄/κ₂²)+3=μ₄/μ₂² 8

Here √β₁ is the index of skewness and β₂ is the index of kurtosis. These indices may be used instead of the third and fourth moments when fitting a distribution to the output of the function F.

Once the moments of each input random variable are determined by the input-moment determiner of FIG. 2A, the moments are passed to the output-moment determiner shown as step 3 in FIG. 2A and described in FIG. 2B.

Before the moments of the output of a function whose input is a number of random variables can be found the moments of the input random variables must be combined in accordance with the function. This is described in the output-moment determiner shown as step 3 of FIG. 1 and in FIG. 2B.

Step 20 of FIG. 2B shows the breaking up of the output function into a sequence of steps involving either 1 or 2 random variables. A counter is then set so that the moments of each step can be determined in step 22. The moments of the output of the function are the moments arising after conducting the last step in the sequence.

Moments of the output of the function whose input is a number of random variables can be found if the function is made up of steps involving well-known operations on one or two independent variables. For example if X and Y are independent random variables and a and b are constants then the following rules apply;
μ′₁(a)=a 9
μ′₁(aX)=aμ′₁(X) 10
μ′₁(X+a)=μ′₁(X) 11
μ′₁(X+Y)=μ′₁(X)+μ′₁(Y) 12
μ′₁(X−Y)=μ′₁(X)−μ′₁(Y) 13
μ′ᵣ(XY)=μ′ᵣ(X)μ′ᵣ(Y) r≧1 14
μ′ᵣ(X^{k})=μ′ₖᵣ(X) k=2, 3, . . . 15
μ₀(X)=1 16
μ₁(X)=0 17
μᵣ(a)=0 r≧1 18
μᵣ(aX)=a^{r}μᵣ(X) r≧0 19
μᵣ(X+a)=μᵣ(X) r≧0 20
κ₁(a)=a 21
κᵣ(a)=0 r≧2 22
κᵣ(aX)=a^{r}κᵣ(X) r≧1 23
κᵣ(X+a)=κᵣ(X)+κᵣ(a) r≧1 24
κᵣ(X+Y)=κᵣ(X)+κᵣ(Y) r≧1 25
κᵣ(aX+bY)=a^{r}κᵣ(X)+b^{r}κᵣ(Y) r≧1 26
κᵣ(X−Y)=κᵣ(X)+(−1)^{r}κᵣ(Y) r≧1 27
where for the above rules r is an integer.

Determining the r^{th} central moment for the product of two variables is more complicated. This is most easily done by writing X=μₓ+δₓ and Y=μ_{y}+δ_{y} where μₓ≡μ′₁(X) and μ_{y}≡μ′₁(Y) and where δₓ and δ_{y} are random deviations. This gives

$$\begin{matrix}{μ}_{r} ( XY ) = E [ {( {μ}_{y} {δ}_{x} + {μ}_{x} {δ}_{y} + {δ}_{x} {δ}_{y} )}^{r} ] \\ = E [ {\sum }_{k = 0}^{r} {\sum }_{j = 0}^{k} \frac{r !}{( r - k ) ! ( k - j ) ! j !} {μ}_{x}^{k - j} {μ}_{y}^{j} {δ}_{x}^{r - k + j} {δ}_{y}^{r - j} ] \\ = {\sum }_{k = 0}^{r} {\sum }_{j = 0}^{k} \frac{r !}{( r - k ) ! ( k - j ) ! j !} {μ}_{x}^{k - j} {μ}_{y}^{j} {μ}_{r - k + j} ( X ) {μ}_{r - j} ( Y )\end{matrix} \qquad 28$$

If X and Y are any variables and if Z is a variable that is equal to X with probability p and equal to Y with probability (1−p) then
μ′ᵣ(Z)=pμ′ᵣ(X)+(1−p)μ′ᵣ(Y).

If X and Y are positive variables and if Z is the variable max {X,Y} then
μ′ᵣ(Z)=0.5 μ′ᵣ(X)+0.5 μ′ᵣ(Y)+0.5 μ′₁({[X^{r}−Y^{r}]²}^{0.5}),
but if Z is the variable min {X,Y} then
μ′ᵣ(Z)=0.5 μ′ᵣ(X)+0.5 μ′ᵣ(Y)−0.5 μ′₁({[X^{r}−Y^{r}]²}^{0.5}).

Division of independent random variables in the function is also within the set of operations for which moments can be determined for the output of the function. Division is the reciprocal of multiplication.

Any step might involve a mathematical operation that is more complicated than those given above, for example the reciprocal operation ƒ(X)=1/X or the operation ƒ(X)=sin X The following is a method for evaluating the moments of the reciprocal and the moments arising from other operations on a variable X. Let μ denote μₓ and μⱼ denote μⱼ(X). Further let δdenote δₓ. If the Taylor's series taken about μₓ for a function ƒ(X) is convergent then

$$f ( X ) = f ( μ ) + {\sum }_{j = 0}^{∞} {( j ! )}^{- 1} {f}^{( j )} ( μ ) {δ}^{j} \qquad 29$$

to which the following definitions apply

$$\begin{matrix}{a}_{j} ≡ ( j ! ) {f}^{( j )} ( μ ) & S ≡ {\sum }_{j = 2}^{∞} {a}_{j} {μ}_{j}\end{matrix} \qquad 30$$

Then
μ′₁(ƒ(X))=ƒ(μ)+S 31

Defining T₀≡−S and Tⱼ≡aⱼδ^{j} for j≧1. Then

$$\begin{matrix}{μ}_{r} ( f ( X ) ) = E [ {\{ f ( X ) - {μ}_{1}^{′} ( f ( X ) ) \}}^{r} ] \\ = E [ {( {\sum }_{j = 0}^{∞} {T}_{j} )}^{r} ]\end{matrix} \qquad 32$$

Expansion of the multinomial gives

$${μ}_{r} ( f ( X ) ) = r ! {\sum }_{{q}_{0} = 0}^{r} {\sum }_{{q}_{1} = 0}^{r = {q}_{0}} {\sum }_{{q}_{2} = 0}^{r - {q}_{0} - {q}_{1}} … E [ {\prod }_{j = 0}^{∞} \frac{{T}_{j}^{{q}_{j}}}{{q}_{j} !} ] \qquad 33$$

The quantity T₀ is a constant so

$${μ}_{r} ( f ( X ) ) = r ! {\sum }_{{q}_{0} = 0}^{r} \frac{{( - S )}^{{q}_{0}}}{{q}_{0} !} [ {\sum }_{{q}_{1} = 0}^{r - {q}_{0}} {\sum }_{{q}_{2} = 0}^{r = {q}_{0} - {q}_{1}} … ( {\prod }_{j = 1}^{∞} \frac{{a}_{j}^{{q}_{j}}}{{q}_{j} !} ) {μ}_{Q} ] \qquad 34$$

where Q≡1q₁+2q₂+3q₃+ . . .

To evaluate the moments of ƒ(X) from μ and {μᵣ} using the equations given above the only elements required are {aⱼ} which are given below for some common operations.

$$\begin{matrix}f ( X ) = 1 / X & {a}_{j} = {( - 1 )}^{j} / {μ}^{j + 1} & 35 \\ f ( X ) = ln X & {a}_{j} = {( - 1 )}^{j + 1} / {μ}^{j} & 36 \\ f ( X ) = exp X & {a}_{j} = exp ( μ ) / j ! & 37 \\ f ( X ) = {X}^{b} & {a}_{j} = b ( b - 1 ) … ( b - j + 1 ) {μ}^{b - j} / j ! & 38 \\ f ( X ) = \sqrt{X} & {a}_{j} = {( - 1 )}^{j + 1} ( \frac{1.3 … ( 2 j - 3 )}{2.4 … 2 j} ) {μ}^{- ( 2 j - 1 ) / 2} & 39 \\ f ( X ) = 1 / \sqrt{X} & {a}_{j} = {( - 1 )}^{j} ( \frac{1.3 … ( 2 j - 1 )}{2.4 … 2 j} ) {μ}^{- ( 2 j + 1 ) / 2} & 40 \\ f ( X ) = cos X & {a}_{j} = \frac{cos ( μ + \frac{j π}{2} )}{j !} & 41 \\ f ( X ) = sin X & {a}_{j} = \frac{sin ( μ + \frac{j π}{2} )}{j !} & 42\end{matrix}$$

Equation 34 above is preferably written as

$${μ}_{r} ( f ( X ) ) = r ! {\sum }_{{q}_{0} = 0}^{r} {( - S )}^{{q}_{0}} H ( r - {q}_{0} ) / {q}_{0} \qquad 43$$

where, for any

$$p = {\sum }_{j = 1}^{∞} {q}_{j} ,$$

$$H ( p ) = {\sum }_{{q}_{1} = 0}^{p} {\sum }_{{q}_{2} = 0}^{p - {q}_{1}} {\sum }_{{q}_{3} = 0}^{p - {q}_{1} - {q}_{2}} … ( {\prod }_{j = 1}^{∞} \frac{{a}_{j}^{{q}_{j}}}{{q}_{j} !} ) {μ}_{Q} \qquad 44$$

H(p) may be evaluated by summing all the terms with a common value of Q into a contribution, h_{Q}(p), and incrementing Q from its minimum value of p until the partial sum H(p)≡hₚ(p)+hₚ₊₁(p)+ . . . satisfies a convergence criterion.

Equations for particular operations on a random variable X are

$$\begin{matrix} {μ}_{r} ( {X}^{2} ) = {\sum }_{{q}_{0} = 0}^{r} {\sum }_{{q}_{1} = 0}^{r - {q}_{0}} \frac{{( - 1 )}^{r - {q}_{0} - {q}_{1}} {2}^{{q}_{1}} r !}{{q}_{0} ! {q}_{1} ! ( r - {q}_{0} - {q}_{1} ) !} {μ}^{{q}_{1}} {μ}_{2}^{r - {q}_{0} - {q}_{1}} {μ}_{2 {q}_{0} + {q}_{1}} & 45 \\ {μ}_{r}^{′} ( {e}^{X} ) = {\sum }_{j = 0}^{∞} {r}^{j} {μ}_{j}^{′} ( X ) / j ! & 46 \\ {μ}_{r}^{′} ( \sqrt{X} ) = {μ}^{r / 2} [ 1 + {\sum }_{j = 2}^{∞} \frac{r ( r - 2 ) … ( r - 2 j + 2 )}{{2}^{j} j !} \cdot \frac{{μ}_{j}}{{μ}^{j}} ] & 47 \\ {μ}_{r}^{′} ( 1 / X ) = {μ}^{- r} [ 1 + {\sum }_{j = 2}^{∞} {( - 1 )}^{j} ( \begin{matrix}r + j - 1 \\ j\end{matrix} ) \frac{{μ}_{j}}{{μ}^{j}} ] & 48\end{matrix}$$

If X is normally distributed then

$$\begin{matrix}{μ}_{1}^{′} ( {e}^{X} ) = exp ( μ + {μ}_{2} / 2 ) & 49 \\ {μ}_{r} ( {e}^{X} ) = exp ( r μ ) {ω}^{r / 2} {\sum }_{j = 0}^{r} {( - 1 )}^{j} ( \begin{matrix}r \\ j\end{matrix} ) {ω}^{( r - j ) ( r - j - 1 ) / 2} & 50\end{matrix}$$

where ω≡exp μ₂. If X is uniformly distributed with non-zero density between a>0 and β>0 then

$$\begin{matrix}{μ}_{r}^{′} ( ln X ) = {\sum }_{k = 0}^{r} {( - 1 )}^{k} \frac{r !}{( r - k ) !} \cdot \frac{b {ln}^{r - k} b - a {ln}^{r - k} a}{b - a} & 51 \\ {μ}_{r}^{′} ( {e}^{X} ) = \frac{{e}^{rB} - {e}^{ra}}{r ( β - α )} & 52 \\ {μ}_{r}^{′} ( \sqrt{X} ) = \frac{2}{r + 2} \cdot \frac{{β}^{1 + r / 2} - {α}^{1 + r / 2}}{β - α} & 53 \\ {μ}_{r}^{′} ( 1 / X ) = \{ \begin{matrix}\frac{1}{β - α} ( ln β - ln α ) & r = 1 \\ \frac{1}{β - α} \cdot \frac{{α}^{1 - r} - {β}^{1 - r}}{r - 1} & r > 1\end{matrix} & 54\end{matrix}$$

Once the moments of the output have been determined these may either be stored in memory, fitted to a distribution, or converted into an interval enclosing a certain percentage of the possible outputs centred (approximately) around the mean of the output.

If the function F can be written in terms of common mathematical operations such as those described above, then the first four moments of the output of the function can be found from the moments of the input variables. These four moments can be transformed into the mean μ′₁, the variance μ₂, the index of skewness √β₁, and the index of kurtosis β₂. From these four measures a distribution can be fitted to the output of the function which is an approximation of the output of the function.

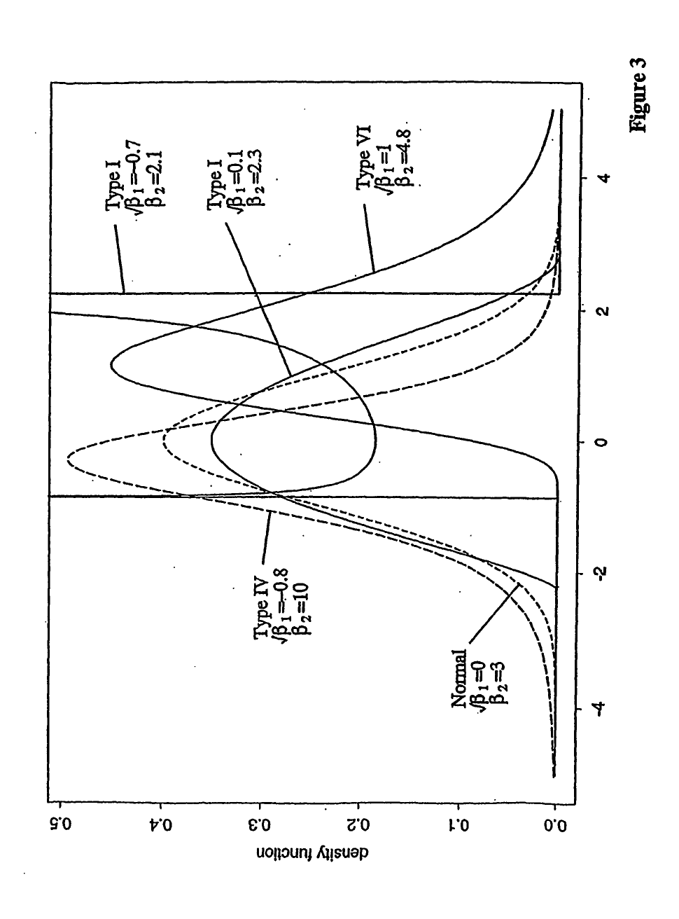

Preferably the approximating distribution is a Pearson distribution. Pearson distributions are a family of four-parameter distributions in which every possible combination of μ′₁, μ₂, √β₁, and β₂ is represented exactly once so the solution exists and is unique. FIG. 3 shows some of the different distributions that are described by Pearson distributions. As can be seen in FIG. 3 the Pearson family includes the normal distribution as well as distributions with a less regular shape. The Pearson system also contains the Student's t, rectangular, beta, arcsine, chi-square and exponential distributions. All of the distributions shown in FIG. 3 are standardized to have a variance of 1.

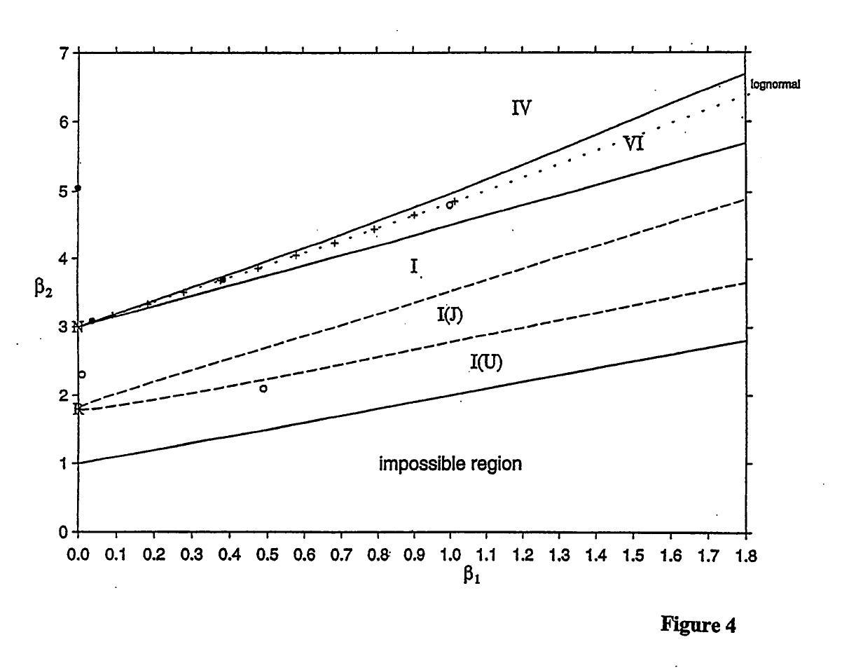

FIG. 4 shows the range of index of skewness and index of kurtosis for which Pearson distributions exist. For all points in the region above the impossible region a unique Pearson distribution exists. The normal distribution is indicated by the letter “N” in FIG. 4 and occupies a single point on the graph. (No distribution, Pearson or otherwise, exists in the impossible region.)

Other distribution families could also be used instead of the Pearson family of distributions. For example in a system using the first four moments the Johnson or Burr family of distributions could be used. There are two advantages of using the Pearson family of distributions to approximate the distribution of the output of the function. The first advantage is that for any set of the first four moments of the output of a function there is a unique Pearson distribution that can be fitted to these moments. The second advantage is that tables and a computer program exist that can be used to determine an interval enclosing a proportion of the output of a function from a Pearson distribution without the distribution itself being required to be calculated.

If using a distribution from the Pearson family of distributions, lower and upper percentage points of the standardized distribution can be read from tables for certain probability levels or calculated approximately for an arbitrary probability level using a computer or calculator. For example a user may be interested in the 2.5 and 97.5 percentiles of the distribution. These can be denoted as q_{L} and q_{U} respectively. Scaling and shifting q_{L} and q_{U} by the standard deviation and the mean gives an interval covering 95% of the distribution of the output of the function as
[μ′₁+q_{L}\sqrt{μ₂}, μ′₁+q_{U}\sqrt{μ₂}] 55

### EXAMPLES

Previously equations have been given for combining the moments of random variables and determining the mean, variance, skewness and kurtosis and other moments of the function F of the input random variables.

The method of the invention will be further described in several examples. The notation ˜ used in the examples means ‘is distributed as’.

### Example 1

In this example, θ₁ is the number of mail orders received by a firm in a month, θ₂ is the value of an order in dollars, and θ₃ is the value in dollars of over-the-counter sales in a month. The total value of sales for a month in dollars is θ+θ₁θ₂+θ₃ which is the function in question. It is known that θ₁ has a normal distribution with mean 12 and variance 4, i.e. θ₁=N(12,4)˜12+2×N(0,1), θ₂ has a normal distribution with mean 8 and unit variance, i.e. θ₂=N(8,1)˜8+N(0,1). The distribution of θ₃ is unknown but a sample of values of θ₃ implies that the mean and low-order central moments of θ₃ are
μ′₁(θ₃)=124 μ′₂(θ₃)=63 μ′₃(θ₃)=21 μ′₄(θ₃)=1734

If θ₁, θ₂ and θ₃ can be assumed to be independent then the method of the invention can be applied. It is possible to approximate a normal distribution with zero mean and variance of one N(0,1) by a normal distribution with zero mean and variance of one truncated 10 standard deviations at either side of the mean N(0,1,a) with a=10. First the data relating to each of the input random variable is stored in computer memory. In this example, the data for θ₁ and θ₂ are in the form of the specifications of distributions and the data for θ₃ are in the form of a sample. Following this the moments of the output of the function are determined from the moments of the input random variables, which are determined from the input data when required. In this case the first four moments are determined for each of the input random variables. In other cases two or three moments may be determined for each of the input random variables or a greater number of moments may be determined for some of the input random variables.

The moments of the output of the function are determined using the equations given earlier. For example the moments about zero for a function of the product of two random variables is given as

$${μ}_{r} ( XY ) = {\sum }_{k = 0}^{r} {\sum }_{j = 0}^{k} \frac{r !}{( r - k ) ! ( k - j ) ! j !} {μ}_{x}^{k - j} {μ}_{y}^{j} {μ}_{r - k + j} ( X ) {μ}_{r - j} ( Y )$$

By this method the moments of the product θ₄=θ₁×θ₂ are found to be,
μ′₁(θ₄)=96 μ′₂(θ₄)=404 μ′₃(θ₄)=2304 μ′₄(θ₄)=508944

Equations have also been given above describing the moments of the output of a function of the sum of two random variables. Using the equations provided a set of moments can be determined for the function of the example. Equations have also been provided describing the relationship between moments about zero and central moments as well as between cumulants and moments.

By this method the moments of the sum θ=θ₄+θ₃ are found to be
μ′₁(θ)=220 μ₂(θ)=467 μ₃(θ)=2325 μ₄(θ)=663390

Further to this there are equations provided that allow the index of skewness \sqrt{β₁} and the index of kurtosis β₂ from either cumulants or moments. Using the equations provided the following moments for the output of the function are determined
\sqrt{β₁}=0.2304 β₂=3.0418

In this case an interval of between 2.5% and 97.5% of the output distribution is required. The lower and upper limits of the interval q_{L} and q_{U} respectively for the values of \sqrt{β₁} and β₂ are obtained by linear interpolation and rounding from tables of distributions covering this range of moments are found to be −1.84 and 2.06. The calculated interval is therefore
[200−1.84 √467, 200+2.06 √467]
which is [160, 245]. This interval is then stored in computer memory and can be displayed on a computer display device.

### Example 2

In this example the function in question is θ=θ₁/θ₂ where θ₁ has a t-distribution with 7 degrees of freedom i.e. θ₁˜t_{7,} and θ₂ has a uniform distribution with lower limit 9 and upper limit 11 i.e. θ₂˜U[9,11]. The input variables are independent.

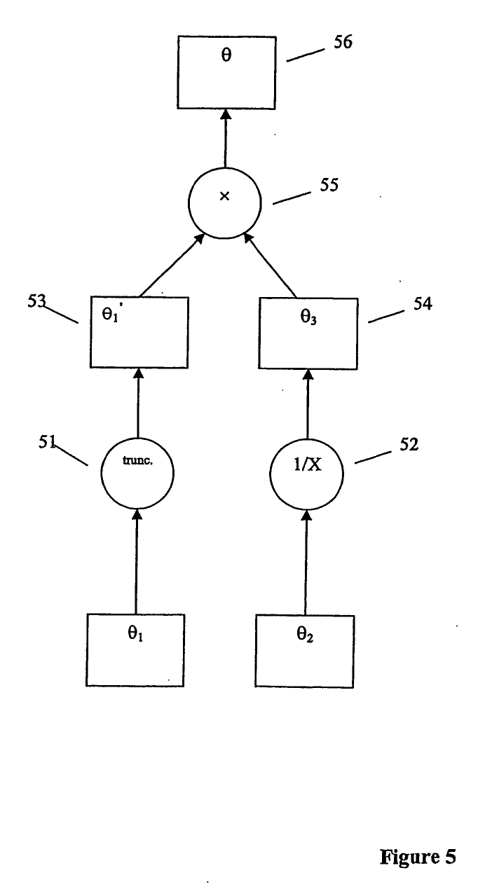

As shown in FIG. 5 θ₁ and θ₂ are the inputs. In step 51 θ₁ is truncated to θ₁*, a t-distribution with 7 degrees of freedom truncated and renormalized at 50 standard deviations i.e. θ₁*˜t₇(50).

In step 53 the first four moments are determined for the truncated and renormalized t-distribution θ₁*. For θ₁* the first four moments are
μ′₁(θ*₁)=0 μ′₂(θ*₁)=1.400 μ′₃(θ*₁)=0 μ′₄(θ*₁)=9.795

For θ₁, the untruncated t-distribution, the second and fourth moments are
μ₂(θ₁)=1.4 μ₄(θ₁)=9.8
which are very close to the second and fourth moments for the truncated t-distribution showing that truncation sufficiently far away from the bulk of the distribution has a minimal effect on the moments of the distribution.

In the function F, θ₁ is divided by θ₂. To overcome the division problem in step 52 θ₃ is defined as θ₃=1/θ₂. In step 54 the moments of θ₃ are determined using the equations given previously. Some of the moments for θ₃ are
μ′₁(θ₃)=0.10034 μ₂(θ₃)=3.383×10⁻⁵ μ₃(θ₃)=2.738×10⁻⁸

The moments of the output of the function are determined from the moments of the input random variables in step 55. Using equations given previously this gives
μ′₁(θ)=0 μ₂(θ)=0.01414 \sqrt{β₁(θ)}=0 β₂(θ)=5.065

In step 56 an interval of between 2.5% and 97.5% of the output distribution is required. The lower and upper limits of the interval q_{L} and q_{U} respectively for the values of √β₁ and β₂ are obtained by linear interpolation and rounding from tables of distributions covering this range of moments and are found to be −2.00 and 2.00 respectively. The 95 % coverage interval for the output of the function is therefore
[−0.238, 0.238]

This interval is then stored in computer memory and can be displayed on a computer display device. Alternatively the moments determined for the output of the function can be fitted to a distribution having the same moments and the distribution may be saved in computer memory.

Again a Monte Carlo simulation of 10⁶ trials was carried out on the same data to assess the accuracy of the method of the invention. The estimate obtained from the Monte Carlo simulation was [−0.2380±0.0007, 0.2380±0.0007]. This is in excellent agreement with the interval obtained using the method of the invention.

### Example 3

In this example, the variable θ₁ is the wind speed relative to some base level, and θ₂ is the temperature relative to some base level, where θ₁ has a uniform distribution with lower limit 9 and upper limit 11 i.e. θ₁˜U[9,11]˜10+U[−1,1,], and θ₂ has a uniform distribution with lower limit 3 and upper limit 3.1 i.e. θ₂U[3,3.1]˜3.05+0.05×U[−1,1]. The input variables are independent. We suppose that the potential of a bush-fire to cause damage is given by the function θ=lnθ₁×exp(θ₂) in some units.

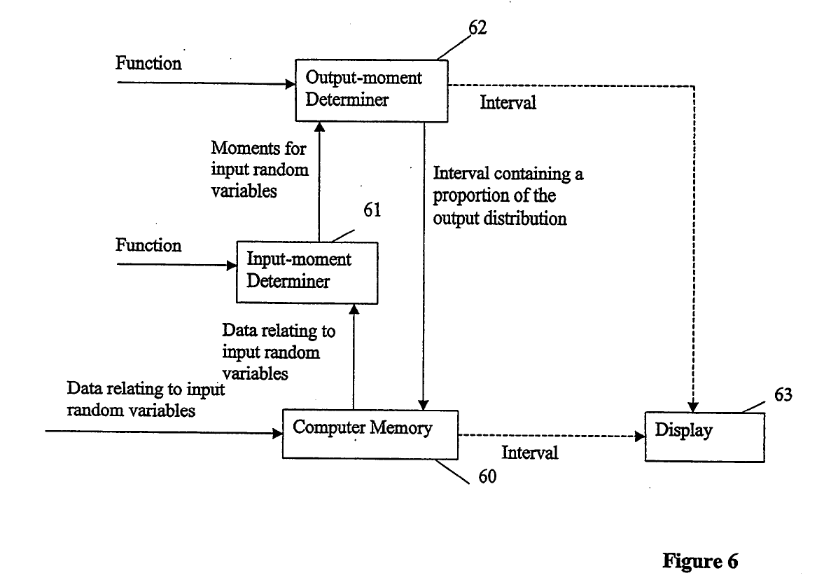

FIG. 6 shows one embodiment of computer implementation of the method of the invention. First the data relating to each of the input random variables is stored in computer memory 60. In this example, the data are in the form of the specifications of distributions. Following this, the data relating to the input random variables are passed from computer memory 60 to input-moment determiner 61. The input-moment determiner truncates and renormalizes the distributions of the input random variables as necessary. This can be seen in step 51 of FIG. 5. The input-moment determiner 61 then determines at least the first and second moments for each input random variable. In this case the first four moments have been determined for each of the input random variables. The number of moments determined for each input random variable may be assessed by the input-moment determiner depending on the number of moments needed by the function to produce the required number of moment for the output of the function.

The output-moment determiner determines the moments of the output of the function F from the moments provided by the input-moment determiner.

In this case the method of the invention gives
μ′₁(θ)=48.569 μ₂(θ)=3.476 \sqrt{β₁(θ)}=0.0314 β₂(θ)=2.389

When an interval describing a specified proportion of the output of function F is required the output-moment determiner determines the interval. In this case an interval of between 2.5% and 97.5% of the output distribution is required. The lower and upper limits of the interval q_{L} and q_{U} respectively for the values of √β₁ and β₂ are obtained by linear interpolation and rounding from tables of distributions covering this range of moments are found to be −1.87 and 1.89. The 95% coverage interval for the output of the function is therefore
[45.1, 52.1]

This interval is then stored in computer memory 60 and can be displayed on a computer display device 63. Alternatively the moments determined for the output of the function can be fitted to a distribution having the same moments and parameters describing the distribution may be saved in computer memory. When a distribution is to be fitted to the output of the function, the output-moment determiner determines the parameters describing the distribution. These may be the moments of the output of the function.

Data for the display 63 may be provided from the computer memory or from the output-moment determiner.

Again a Monte Carlo simulation of 10⁶ trials was carried out on the same data to assess the accuracy of the method of the invention. The estimate obtained from the Monte Carlo simulation was [45.123±0.007, 52.188±0.007]. This is in excellent agreement with the interval obtained using the method of the invention.

### Example 4

As in the Example 3 in this example the function in question is θ=lnθ₁×exp(θ₂). Now θ₁ has an exponential distribution i.e. θ₁˜10+0.4EXP(1), and θ₂ has a t-distribution with 30 degrees of freedom i.e. θ₂˜1+0.2t₃₀. However EXP(1,10) and t₃₀(50) can be used instead of EXP(1) and t₃₀.

First the data relating to each of the input random variable is stored in computer memory. In this example, the data are in the form of the specifications of distributions.

Following this at least the first and second moments are determined for each input random variable. In this case the first four moments have been determined for each of the input random variables. Following this the moments of the output of the function are determined from the moments of the input random variables.

In this example the method of the invention gives
μ′₁(θ)=6.500 μ₂(θ)=1.871 \sqrt{β₁(θ)}=0.722 β₂(θ)=4.284

In this example an interval of between 2.5% and 97.5% of the output distribution is required. The lower and upper limits of the interval q_{L} and q_{U} respectively for the values of √β₁ and β₂ are obtained by linear interpolation and rounding from tables of distributions covering this range of moments are found to be −1.67 and 2.26. The 95% coverage interval for the output of the function is therefore
[4.23, 9.58]

This interval is then stored in computer memory and can be displayed on a computer display device. Alternatively the moments determined for the output of the function can be fitted to a distribution having the same moments and parameters describing the distribution may be saved in computer memory.

Again a Monte Carlo simulation of 10⁶ trials was carried out on the same data to assess the accuracy of the method of the invention. The estimate obtained from the Monte Carlo simulation was [4.227±0.006, 9.580±0.012]. This is in excellent agreement with the interval obtained using the method of the invention. Using EXP(1,20) does not alter the moments quoted above.

Throughout the examples Monte Carlo simulations have been used to assess the accuracy of the method of the invention. These trials show that the intervals obtained using the method of the invention are very close to those obtained using Monte Carlo simulations. This shows that the method of the invention provides an accurate method for determining an interval enclosing a proportion of the output of a function with a plurality of input random variables or parameters describing a distribution of the output of a function with a plurality of input random variables. One advantage of using a method of the invention is that it is less computationally expensive then performing Monte Carlo simulations.

The foregoing describes the invention including preferred forms thereof. Alterations and modifications as will be obvious to those skilled in the art are intended to be incorporated within the scope hereof as defined by the accompanying claims.

1. A method for determining a characteristic of the output distribution of a function whose inputs include at least two random variables with different forms of distribution including the steps of:
retrieving data relating to one or more input random variables from computer memory,
determining at least the first two moments of each input random variable from the retrieved data,
determining at least the first two moments of the output of the function from moments of the input random variables,
storing the moments of the output of the function in computer memory.

2. A method for determining a characteristic of the output distribution of a function whose inputs include random variables as claimed in claim 1 further including the step of determining the index of skewness (\sqrt{β₁}) for the output of the function from the moments of the output of the function.

3. A method for determining a characteristic of the output distribution of a function whose inputs include random variables as claimed in claim 1 further including the step of determining the index of kurtosis (β₂ ) for the output of the function from the moments of the output of the function.

4. A method for determining a characteristic of the output distribution of a function whose inputs include random variables as claimed in claim 1 wherein if an input random variable has a distribution with an infinite tail or tails the method further includes the steps of truncating the distribution and renormalizing the truncated distribution.

5. A method for determining a characteristic of the output distribution of a function whose inputs include random variables as claimed in claim 1 further including the step of determining an interval enclosing a proportion of the output distribution of the function from the determined moments of the output of the function.

6. A method for determining a characteristic of the output distribution of a function whose inputs include random variables as claimed in claim 5 wherein the step of determining the interval enclosing a proportion of the function includes the step of retrieving the percentage of the distribution of the output to be represented and determining an interval enclosing that percentage.

7. A method for determining a characteristic of the output distribution of a function whose inputs include random variables as claimed in claim 5 wherein equal parts of the upper and lower ends of the distribution are excluded from the interval.

8. A method for determining a characteristic of the output distribution of a function whose inputs include random variables as claimed in claim 1 further including the step of fitting a distribution to the output of the function with the same moments as those determined for the output of the function from the moments of the input random variables of the function.

9. A method determining a characteristic of the output distribution of a function whose inputs include random variables as claimed in claim 8 wherein the step of fitting a distribution to the output of the function includes the step of fitting a distribution to the function with the same mean, variance, index of skewness and index of kurtosis as the output of the function.

10. A method of determining a characteristic of the output distribution of a function whose inputs include random variables as claimed in claim 8 wherein the distribution fitted to the output of the function is a Pearson distribution.

11. A method of determining a characteristic of the output distribution of a function whose inputs include random variables as claimed in claim 8 wherein the distribution fitted to the output of the function is a Johnson distribution.

12. A method of determining a characteristic of the output distribution of a function whose inputs include random variables as claimed in claim 8 wherein the distribution fitted to the output of the function is a Burr distribution.

13. A system for determining a characteristic of the output distribution of a function configured to take as input random variables including at least two random variables with different forms of distribution and to output a characteristic of the distribution of a function having as input the random variables, the system comprising
data relating to one or more input random variables stored in computer memory,
an input-moment determiner configured to retrieve the data relating to each input random variable from computer memory and determine at least the first two moments of each input random variable from the retrieved data, and
an output-moment determiner configured to determine at least the first two moments of the output of the function from moments of the input random variables,
an output determiner configured to determine a characteristic of the output distribution of the function from the determined moments of the output of the function and store the characteristic in computer memory or display the characteristic.

14. A system for determining a characteristic of the output distribution of a function configured to take as input random variables including at least two random variables with different distributions and to output a characteristic of the distribution of a function having as input the random variables as claimed in claim 13 further configured to determine the index of skewness (\sqrt{β₁}) for the output of the function from the moments of the output of the function.

15. A system for determining a characteristic of the output distribution of a function configured to take as input random variables including at least two random variables with different distributions and to output a characteristic of the distribution of a function having as input the random variables as claimed in claim 13 further configured to determine the index of kurtosis (β₂ ) for the output of the function from the moments of the output of the function.

16. A system for determining a characteristic of the output distribution of a function configured to take as input random variables including at least two random variables with different distributions and to output a characteristic of the distribution of a function having as input the random variables as claimed in claim 13 further configured to truncate and renormalize the distribution of any input random variable that has a distribution with an infinite tail or tails.

17. A system for determining a characteristic of the output distribution of a function configured to take as input random variables including at least two random variables with different distributions and to output a characteristic of the distribution of a function having as input the random variables as claimed in claim 13 wherein the characteristic of the output distribution of a function is an interval enclosing a specific proportion of the distribution of the function.

18. A system for determining a characteristic of the output distribution of a function configured to take as input random variables including at least two random variables with different distributions and to output a characteristic of the distribution of a function having as input the random variables as claimed in claim 17 wherein the output determiner is further configured to retrieve the percentage of the distribution of the output to be represented from computer memory and determine an interval enclosing that percentage.

19. A system for determining a characteristic of the output distribution of a function configured to take as input random variables including at least two random variables with different distributions and to output a characteristic of the distribution of a function having as input the random variables as claimed in claim 17 wherein the output determiner is further configured to exclude equal parts of the upper and lower ends of the distribution.

20. A system for determining a characteristic of the output distribution of a function configured to take as input random variables including at least two random variables with different distributions and to output a characteristic of the distribution of a function having as input the random variables as claimed in claim 13 wherein the characteristic of the output distribution of a function is a distribution with the same moments as those determined for the output of the function from the moments of the random input variables of the function.

21. A system for determining a characteristic of the output distribution of a function configured to take as input random variables including at least two random variables with different distributions and to output a characteristic of the distribution of a function having as input the random variables as claimed in claim 20 wherein the output determiner is further configured to fit a distribution to the output of the function with the same mean, variance, index of skewness and index of kurtosis as those determined for the output of the function.

22. A system for determining a characteristic of the output distribution of a function configured to take as input random variables including at least two random variables with different distributions and to output a characteristic of the distribution of a function having as input the random variables as claimed in claim 20 wherein the output determiner is further configured to fit a Pearson distribution to the output of the function.

23. A system for determining a characteristic of the output distribution of a function configured to take as input random variables including at least two random variables with different distributions and to output a characteristic of the distribution of a function having as input the random variables as claimed in claim 20 wherein the output determiner is further configured to fit a Johnson distribution to the output of the function.

24. A system for determining a characteristic of the output distribution of a function configured to take as input random variables including at least two random variables with different distributions and to output a characteristic of the distribution of a function having as input the random variables as claimed in claim 20 wherein the output determiner is further configured to fit a Burr distribution to the output of the function.

25. A method for determining a characteristic of the output distribution of a function whose inputs include random variables including the steps of:
retrieving data relating to one or more input random variables from computer memory,
determining at least the first two moments of each input random variable from the retrieved data,
determining at least the first two moments of the output of the function from moments of the input random variables, wherein the function includes at least one operator from the group of exponentials, logarithms, division, multiplication, positive and negative exponents, and trigonometric operators, and
storing the moments of the output of the function in computer memory.

26. A system for determining a characteristic of the output distribution of a function configured to take as input random variables and to output a characteristic of the distribution of a function having as input the random variables, the system comprising:
data relating to one or more input random variables stored in computer memory,
an input-moment determiner configured to retrieve the data relating to each input random variable from computer memory and determine at least the first two moments of each input random variable from the retrieved data, and
an output-moment determiner configured to determine at least the first two moments of the output of the function from moments of the input random variables, wherein the function includes at least one operator from the group of exponentials, logarithms, division, multiplication, positive and negative exponents, and trigonometric operators, and
an output determiner configured to determine a characteristic of the output distribution of the function from the determined moments of the output of the function and store the characteristic in computer memory or display the characteristic.
